(19) United States
(12) Patent Application Publication
(10) Pub. No.: US 2009/0156082 A1
(43) Pub. Date: Jun. 18, 2009

(54) Apparatus for Transferring Substrate

(75) Inventor: Jui-Chung Cheng, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: PRIME VIEW INTERNATIONAL CO., LTD., Hsinchu (TW)

(21) Appl. No.: 12/104,687

(22) Filed: Apr. 17, 2008

(30) Foreign Application Priority Data
Dec. 14, 2007 (TW) 96148009

(51) Int. Cl. H01J 9/48

(52) U.S. Cl. 445/24

(57) ABSTRACT

An apparatus for transferring at least one substrate includes a base, a plurality of forks and at least one fastener. The base has a side surface. The forks are disposed on the side surface of the base and parallel to each other. The fastener is disposed on each of the forks.

### RELATED APPLICATIONS

This application claims priority to Taiwan Application Serial Number 96148009, filed Dec. 14, 2007, which is herein incorporated by reference.

### BACKGROUND

1. Field of Invention

The present invention relates to an apparatus for manufacturing a flat-panel display. More particularly, the present invention relates to an apparatus for transferring at least one substrate.

2. Description of Related Art

Flat-panel displays have many advantages over other conventional displays, including high picture quality, small volume occupation, light weight, low voltage drive and low power consumption. Hence, flat-panel displays are widely used in small portable televisions, mobile telephones, video recording units, notebook computers, desktop monitors, projector televisions and so on. The flat-panel display is gradually replacing the conventional cathode ray tube (CRT) as a mainstream display unit.

Generally, flat-panel displays are mainly made of glass substrates. Therefore, a manufacturer has to transfer the glass substrates between each process when manufacturing the flat-panel displays. Hence, how to transfer the glass substrates has been an issue for the pertinent field.

### SUMMARY

According to one embodiment of the present invention, an apparatus for transferring at least one substrate includes a base, a plurality of forks and at least one fastener. The base has a side surface. The forks are disposed on the side surface of the base and parallel to each other. The fastener is disposed on each of the forks.

According to another embodiment of the present invention, an apparatus for transferring at least one substrate includes a base, a plurality of forks and at least one fastener. The base has a side surface. The forks are disposed on the side surface of the base and spaced a height apart. The fastener is disposed on each of the forks.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a three dimensional view of an apparatus for transferring at least one substrate according to one embodiment of the present invention.

FIG. 2 is a three dimensional view of the apparatus of FIG. 1, showing the apparatus in operation.

FIG. 3 is a functional block diagram, showing the detector and the actuator of FIG. 2.

### DETAILED DESCRIPTION

When manufacturing flat-panel displays, a manufacturer often needs to transfer glass substrates from one cassette to another cassette. For example, the manufacturer usually takes the glass substrates out from the feed cassette and then puts the glass substrates into the discharge cassette for further operations. However, a typical robot can take only one glass substrate at a time and fails to take a plurality of glass substrates simultaneously. Therefore, the transferring process mentioned above is time consuming and thus lessens the manufacturing efficiency. Accordingly, the following embodiment of the present invention provides an apparatus, which has a plurality of forks to transfer a plurality of substrates simultaneously.

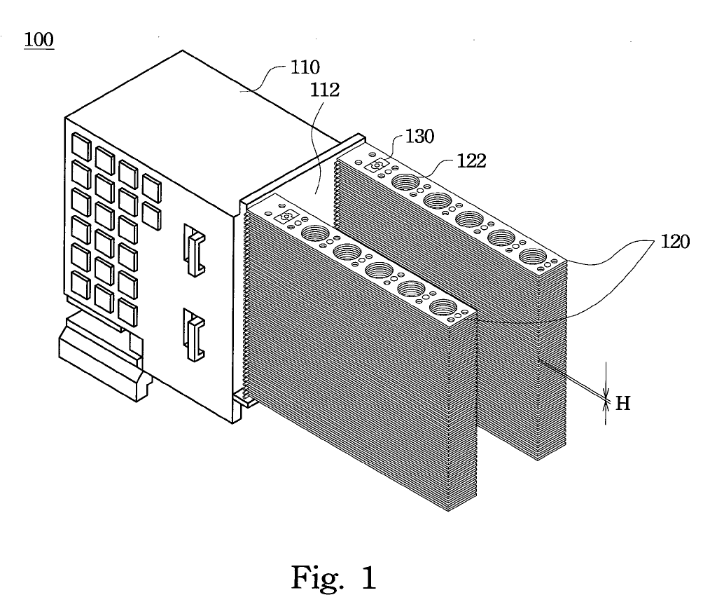

FIG. 1 is a three dimensional view of an apparatus 100 for transferring at least one substrate according to one embodiment of the present invention. The apparatus 100 includes a base 110, a plurality of forks 120 and at least one fastener 130. The base 110 has a side surface 112. The forks 120 are disposed on the side surface 112 of the base 110 and parallel to each other. The fastener 130 is disposed on each of the forks 120. The term “parallel” in the present embodiment is interpreted as “two things that are parallel to each other are the same distance apart along their whole length/width”. For example, the forks 120 are spaced the same height H apart along their whole length/width.

In the present embodiment, the forks 120 of the apparatus 100 may be designed to fit a cassette, which contains a plurality of the substrates. Accordingly, the apparatus 100 may transfer all of the substrates inside the cassette simultaneously and not take only one of the substrates at a time.

The fastener 130 of FIG. 1 may be a vacuum fastener. It is easily understood that the vacuum fastener as the fastener 130 is only one of the examples. The fastener 130 can also be another proper fastener (for example, a guide pin). People skilled in the art can select a proper fastener if necessary.

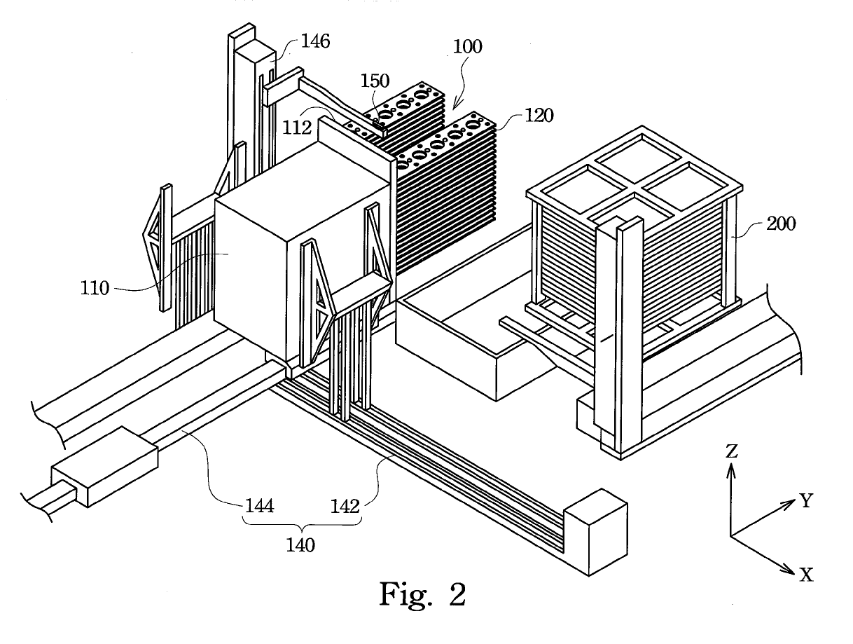

FIG. 2 is a three dimensional view of the apparatus 100 of FIG. 1, showing the apparatus in operation. The apparatus 100 may further include a detector 150 and an actuator (not shown). In use, the detector 150 may detect whether at least one of the forks 130 supports the substrate. The actuator may actuate the fastener 130, i.e. the vacuum fastener, to attract the substrate when at least one of the forks 130 supports the substrate.

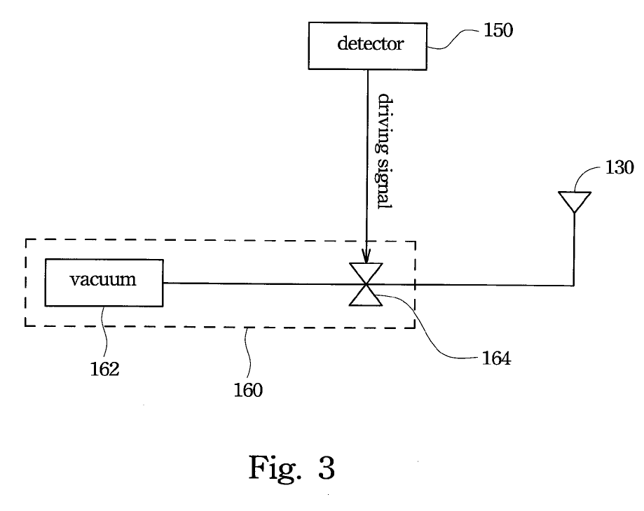

FIG. 3 is a functional block diagram, showing the detector 150 and the actuator of FIG. 2. The actuator 160 of FIG. 3 may include a vacuum 162 and a solenoid valve 164. The vacuum 162 is connected to the fastener 130 to provide an attractive force thereto. The solenoid valve 164 is connected between the vacuum 162 and the fastener 130. In use, the detector 150 may transmit a driving signal to the solenoid valve 164 when at least one of the forks supports the substrate. Then, the solenoid valve 164 is opened to actuate the fastener 130, i.e. the vacuum fastener, to attract the substrate.

Reference is made to FIG. 2. The apparatus 100 may further include a rail system 140 coupled to the base 110. The rail system 140 can enable the apparatus 100 to move to a destination, i.e. the cassette 200, after the substrates are loaded onto the apparatus 100. More specifically, the rail system 140 may have a plurality of tracks 142/144 perpendicular to each other. The length direction of the track 142 is parallel to the X-axis coordinates, and the length direction of the track 144 is parallel to the Y-axis coordinates. Furthermore, a cylinder 146 may be coupled to the base 110 as well to lift/lower the apparatus 100; that is, the cylinder 146 can enable the apparatus 100 to move along the Z-axis coordinates.

In use, the apparatus 100 may move to the cassette 200 along the rail system 140 after the substrates are loaded onto the apparatus 100. Then, the solenoid valve 164 of FIG. 3 is closed to release the substrates from the fastener 130 and thus load the substrates into the cassette 200. Finally, the apparatus 100 may leave the cassette 200 to finish the transferring process. In one working example of the present invention, the operation time for the transferring process was less than 1 min, wherein the velocity of the apparatus 100 was between 1000 mm/min and 200 mm/min.

Furthermore, each of the forks 120 may be made of an antistatic material to reduce or eliminate buildup of static electricity generally caused by loading/unloading the substrates. It is easily understood that the antistatic material is only one of the examples. The forks 120 can also be made of another proper material, such as an insulating material, e.g. plastic or ceramics, or a semiconductor material whose surface resistivity is between 10³ Ω/m² and 10⁵ Ω/m².

Moreover, each of the forks 120 of FIG. 1 may have a plurality of holes 122 disposed thereon to reduce the weight of the forks 120. The size and the amount of the holes 122 may depend on the strength of the forks 120. People skilled in the art can practice the holes 122 according to actual requirements.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An apparatus for transferring at least one substrate, the apparatus comprising:
a base having a side surface;
a plurality of forks disposed on the side surface of the base and parallel to each other; and
at least one fastener disposed on each of the forks.

2. The apparatus of claim 1, further comprising:
a rail system coupled to the base.

3. The apparatus of claim 2, wherein the rail system has a plurality of tracks perpendicular to each other.

4. The apparatus of claim 1, wherein the fastener is a vacuum fastener.

5. The apparatus of claim 4, further comprising:
a detector for detecting whether at least one of the forks supports the substrate; and
an actuator for actuating the vacuum fastener to attract the substrate when at least one of the forks supports the substrate.

6. The apparatus of claim 1, wherein each of the forks is made of an antistatic material.

7. The apparatus of claim 1, wherein each of the forks is made of an insulating material.

8. The apparatus of claim 1, wherein each of the forks is made of plastic or ceramics.

9. The apparatus of claim 1, wherein each of the forks is made of a semiconductor material.

10. The apparatus of claim 1, wherein each of the forks has a plurality of holes disposed thereon.

11. An apparatus for transferring at least one substrate, the apparatus comprising:
a base having a side surface;
a plurality of forks disposed on the side surface of the base and spaced a height apart; and
at least one fastener disposed on each of the forks.

12. The apparatus of claim 11, further comprising:
a rail system coupled to the base.

13. The apparatus of claim 12, wherein the rail system has a plurality of tracks perpendicular to each other.

14. The apparatus of claim 11, wherein the fastener is a vacuum fastener.

15. The apparatus of claim 14, further comprising:
a detector for detecting whether at least one of the forks supports the substrate; and
an actuator for actuating the vacuum fastener to attract the substrate when at least one of the forks supports the substrate.

16. The apparatus of claim 11, wherein each of the forks is made of an antistatic material.

17. The apparatus of claim 11, wherein each of the forks is made of an insulating material.

18. The apparatus of claim 11, wherein each of the forks is made of plastic or ceramics.

19. The apparatus of claim 11, wherein each of the forks is made of a semiconductor material.

20. The apparatus of claim 11, wherein each of the forks has a plurality of holes disposed thereon.
